(19) United States
(12) Patent Application Publication
(10) Pub. No.: US 2024/0181532 A1
(43) Pub. Date: Jun. 6, 2024

(54) METHOD AND APPARATUS FOR GAS HEAD CLEANING

(71) Applicant: VulcanForms Inc., Burlington, MA (US)

(72) Inventors: Raghav Aggarwal, Somerville, MA (US); Jeffrey M. LeBlanc, Burlington, MA (US); Joseph D. Sandt, Evanston, IL (US); Yiannis Kaparos, Newton Highlands, MA (US); Corey Murphy, Lincoln, RI (US); Stephen Elliot Wei, Medford, MA (US)

(73) Assignee: VulcanForms Inc., Burlington, MA (US)

(21) Appl. No.: 18/524,240

(22) Filed: Nov. 30, 2023

Related U.S. Application Data
(60) Provisional application No. 63/429,215, filed on Dec. 1, 2022.

(51) Int. Cl. B22F 10/47; B22F 12/90

(52) U.S. Cl. CPC B22F 10/47; B22F 12/90; B22F 10/28

(57) ABSTRACT

An additive manufacturing system includes a build surface, one or more laser energy sources, and an optics assembly movable relative to the build surface. The optics assembly directs laser energy from the one or more laser energy sources toward the build surface to fuse a portion of a precursor material on the build surface. A gas head is operatively coupled to the optics assembly and movable relative to the build surface. The gas head entrains emitted materials released during fusion of the precursor material. The system also includes a gas head cleaning device having a scraper to remove debris from a surface of the gas head.

### RELATED APPLICATION

This application claims priority under 35 U.S.C. § 119(e) to U.S. Provisional Application No. 63/429,215, filed Dec. 1, 2022, the content of which is incorporated by reference in its entirety for all purposes.

### FIELD

Disclosed embodiments are related to methods and apparatus for cleaning a gas head, e.g., for an additive manufacturing system.

### BACKGROUND

In selective laser melting processes for additive manufacturing, one or more laser spots may be scanned over or otherwise applied to a thin layer of a powder. The powder that is exposed to laser energy may be melted and fused into a solid structure. Once a layer is completed, a new layer of powder may be laid down and the process may be repeated. The new layer may be selectively exposed to laser energy with at least some portions of powder material melted and fused onto the solid material from the prior layer. This process can be repeated many times in order to build up a three-dimensional shape of nearly any form.

### SUMMARY

Melting of powder material can cause various materials to be ejected or otherwise produced at or near the melt site, and such emitted materials can interfere with various aspects of the process including interfering with accurate directing of laser energy to selected portions of the powder material. In some systems, gas heads are employed to help remove emitted materials, e.g., by using a vacuum or other relatively low pressure to draw the materials into the gas head and conduct them away from a work area. However, the emitted materials can deposit on the gas head and accumulate. In some cases, the accumulated material on a gas head can be dislodged from the gas head over a work surface and potentially contaminate a structure being built on the work surface. Aspects of the disclosure relate to methods and apparatus for cleaning a gas head of accumulated materials.

In some embodiments, an additive manufacturing system may comprise a build surface, one or more laser energy sources, and an optics assembly movable relative to the build surface. The optics assembly may be configured to direct laser energy from the one or more laser energy sources toward the build surface to fuse a portion of a precursor material on the build surface. A gas head may be operatively coupled to the optics assembly and movable relative to the build surface. The gas head may be configured to entrain emitted materials released during fusion of the precursor material. The system may further comprise a gas head cleaning device having a scraper configured to remove debris from a surface of the gas head. In some embodiments, the build surface, the gas head, and the gas head cleaning device may be disposed within a build volume of the additive manufacturing system. Additionally or alternatively, some systems may further comprise a cleaning area separate from the build surface, and the gas head cleaning device may be disposed in the cleaning area.

Some gas head cleaning devices may comprise a longitudinal shaft and one or more limbs extending radially from the longitudinal shaft, and each limb may comprise a scraper. Further, in some embodiments, the longitudinal shaft may be coupled to at least one of a motor configured to rotate the longitudinal shaft about a longitudinal axis of the shaft, and a linear actuator configured to translate the gas head cleaning device in a liner direction. Some systems may comprise the linear actuator, and the linear actuator may be configured to move the gas head cleaning device between a storage position below the build surface and a cleaning position above the build surface. Additionally or alternatively, the one or more limbs may comprise a first limb extending in a first radial direction from the longitudinal shaft and a second limb extending in a second radial direction opposite the first radial direction. In some such systems, the first limb may extend from a first point along the longitudinal shaft and the second limb may extend from a second point along the longitudinal shaft. In some embodiments, the second point may be offset from the first point. In some embodiments, the first limb and the second limb may extend from a same point along the longitudinal shaft. Additionally or alternatively, the one or more limbs may comprise a first limb extending from a first point along the longitudinal shaft in a first radial direction, and the first limb may have a first scraper configured to clean a first surface of the gas head. The one or more limbs may further comprise a second limb extending from a second point along the longitudinal shaft in the first direction. The second limb may have a second scraper configured to clean a second surface of the gas head. In some embodiments, at least one limb may have a first scraper extending from a first side of the limb configured to clean a first surface of the gas head, and a second scraper extending from a second side of the limb configured to clean a second surface of the gas head. In some embodiments, the surface of the gas head may be disposed at an angle relative to the build surface, and an angle of at least one limb relative to the longitudinal shaft may be selected to correspond to the angle of the surface. Additionally or alternatively, each scraper may be selectively removable from the respective limb, and each limb may comprise a slot configured to slidably receive a coupling root of the respective scraper. In some embodiments, each scraper may comprise a metallic brush or a plastic brush.

In some embodiments, a method of cleaning a gas head of an additive manufacturing system may comprise moving the gas head to an area of the additive manufacturing system suitable for cleaning the gas head, separating debris from a surface of the gas head with a gas head cleaning device of the system, and removing debris from the gas head. According to some embodiments, moving the gas head to the area of the additive manufacturing system suitable for cleaning the gas head may comprise moving the gas head to a cleaning area adjacent to and separate from a build surface of the additive manufacturing system. Additionally or alternatively, separating debris from the surface of the gas head may comprise separating debris from an internal surface of the gas head. Further, in some embodiments, separating debris from the internal surface of the gas head may comprise separating debris from an upper internal surface and/or a lower internal surface of the gas head. In some embodiments, separating debris from the surface of the gas head may additionally or alternatively comprise separating debris from an external surface of the gas head.

In some embodiments, separating debris from the surface of the gas head may comprise separating debris from a first surface with a first scraper of the gas head cleaning device, and separating debris from a second surface with a second scraper of the gas head cleaning device. The first and second surfaces may be on a first duct of the gas head, and the debris may be separated from the first and second surfaces simultaneously. Alternatively, the first surface may be on a first duct of the gas head and the second surface may be on a second duct of the gas head. In some such embodiments, debris may be separated from the first and second surfaces simultaneously. In other such embodiments, separating debris from the second surface may comprise moving the first duct from an extended configuration to a retracted configuration to space the first surface apart from the first scraper, and moving the second duct from a retracted configuration to an extended configuration to place the second scraper in contact with the second surface.

In some embodiments, separating debris from the surface of the gas head may comprise moving the gas head cleaning device from a storage position below a build surface of the additive manufacturing system to a cleaning position above the build surface, engaging a scraper of the gas head cleaning device with the surface of the gas head, and moving the gas head in at least one direction to pass the scraper along the surface of the gas head. Further, in some embodiments, moving the gas head cleaning device from the storage position to the cleaning position may comprise translating the gas head cleaning device in a linear direction, and engaging the scraper of the gas head cleaning device with the surface of the gas head may comprise rotating the gas head cleaning device to place the scraper in contact with the surface. In some such embodiments, translating the gas head cleaning device in the linear direction may comprise moving at least a portion of the gas head cleaning device into a gap between two ducts of the gas head. In some embodiments, separating debris from the surface of the gas head may comprise dislodging debris from the surface using a brush of the gas head cleaning device. Additionally or alternatively, removing debris from the gas head may comprise creating a flow of gas through the gas head, and entraining debris in the flow of gas.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a schematic view of an additive manufacturing system according to some embodiments;

FIG. 2 is a top view of a gas head during operation of an additive manufacturing system according to some embodiments;

FIG. 3 is a cross-sectional view of the gas head of FIG. 2 taken along the line B-B;

FIG. 4 is the cross-sectional view of FIG. 3 including a gas head cleaning device according to some embodiments;

FIG. 5 is a side view of a gas head cleaning device according to some embodiments;

FIG. 6 is a cross-sectional view of a first limb of the gas head cleaning device of FIG. 5 taken along line C-C;

FIG. 7A is a cross-sectional view of a second limb of the gas head cleaning device of FIG. 5 taken along line D-D;

FIG. 7B is the cross-sectional view of FIG. 7A, with scrapers of the limb modified to include blades according to some embodiments;

FIG. 7C is the cross-sectional view of FIG. 7A, with scrapers of the limb modified to include air blades according to some embodiments;

FIG. 7D is the cross-sectional view of FIG. 7A, with the limb modified to include a single scraper formed integrally with the limb according to some embodiments;

FIG. 8 is a front view of a gas head cleaning device and associated actuation system, according to some embodiments;

FIG. 9A is a top view of a gas head and a gas head cleaning device during a cleaning operation, according to some embodiments;

FIG. 9B is the top view of FIG. 9A with the gas head cleaning device rotated to clean the gas head, according to some embodiments; and

FIG. 10 is a flow chart depicting a method of cleaning a gas head of an additive manufacturing system, according to some embodiments.

### DETAILED DESCRIPTION

Some additive manufacturing systems may iteratively melt or fuse selective portions of sequential layers of precursor material to build a product from the fused material. For example, some laser powder bed fusion (LPBF) additive manufacturing systems may use lasers to melt or fuse a precursor material such as a powdered metal, plastic, polymer, or other material. In some embodiments, layers of the precursor material may be sequentially deposited on a build surface. Laser energy may be selectively directed at each layer in order to melt and/or fuse a portion of the deposited layer. The melted portion of the precursor material may be referred to as a melt pool. In some applications, dynamics within the melt pool may result in a degree of gasification of the precursor material, which may result in the generation of fumes from the melt pool. Moreover, the gasification and rapid expansion of powdered and molten material may also cause the melt pool to eject solid and/or liquid particles from the melt pool. Various types of fusion products, ejecta, or other emitted material from a melt pool during a laser melt process (e.g., individual powder particles, partially fused powder particles, molten droplets or cooled molten droplets, fumes from the melt pool, etc.) may cause a number of problems during the build process and in the final part.

Some additive manufacturing systems may include a device known as a gas head to remove the fusion products, ejecta, or other emitted material. In some instances, a gas head may create and/or control a flow of gas across a portion of a build surface to entrain the fusion products. For example, a gas head may be fluidly coupled to one or more vacuum sources or air flow generators (e.g., pumps, fans, etc.) to create a flow of gas. In some embodiments, a gas head may create a localized flow of gas at an area of the build surface near a melt pool to remove the fusion products, ejecta, or other emitted material, e.g., to help prevent the emitted material from disrupting the build process or compromising the final part. The flow of gas may entrain the emitted material and carry it away from the melt pool and/or build volume in which the part is built.

However, in some instances, emitted material may adhere to or be deposited on the gas head rather than being removed from the build volume. If the adhered emitted material subsequently becomes dislodged during a build process, the emitted material may fall onto the build surface or into the powder bed. This loose debris may disrupt the build process by disturbing the powder bed, and may compromise the final built part. For example, debris in the powder bed may result in inclusions, overbuilds, voids, delamination between build layers, or distortion in a final built component. Debris in the powder bed may also result in damage to the system, including damage to a recoating blade of the system which may be used to deposit the layers of powder.

In view of the above, the inventors have recognized and appreciated the benefits of an additive manufacturing system which includes a cleaning device to safely remove fusion products, ejecta, or other emitted material which have adhered to, deposited, or otherwise collected on a gas head. In some embodiments, a cleaning device may include a scraper, such as a brush, a blade, or an air jet, configured to dislodge debris from the gas head. Once dislodged, loose debris may be carried away by the flow of gas within the gas head, allowed to fall away from the gas head or otherwise handled. Additionally or alternatively, this cleaning process may be performed in a cleaning area of the additive manufacturing system or build volume that is away from the build surface, powder bed, or other sensitive areas. Loose debris that is not carried away on the flow of gas may fall harmlessly within the cleaning area, where it may be left to accumulate or be removed by an operator at an appropriate time.

In some embodiments, a gas head cleaning device may have a scraper configured to remove emitted material from a gas head. A scraper may be any mechanism appropriate for dislodging, scraping, separating, cleaning, or otherwise removing debris from a gas head. In various embodiments, a scraper may comprise a brush, an edge, a blade, an air jet, an air knife, a scouring pad, or any other appropriate mechanism. Additionally, a scraper may be formed of any appropriate material. In some embodiments, a scraper may be formed from a rigid or flexible plastic such as nylon, polyethylene, polyurethane (including thermoplastic polyurethane (TPU)), acrylonitrile butadiene styrene (ABS), polycarbonate (PC), or any other appropriate plastic. In some embodiments, a scraper may be formed from a metal such as brass, copper, aluminum, nickel, steel, or any other appropriate metal or alloy. In some embodiments, a scraper may be formed from a polymer, a composite material such as carbon fiber, or from a ceramic material. In some embodiments, a scraper may be formed from plastic in order to prevent damage to a gas head, which may be formed from metal. Alternatively, a scraper may be formed from metal in order to enhance a durability of the scraper. In some embodiments, a scraper may comprise an ultrasonic agitator or ultrasonic horn configured to impart ultrasonic vibrations to the gas head to dislodge or otherwise separate emitted material from a gas head or a surface thereof.

With regard to materials used for a scraper, the inventors have appreciated that there is a risk that fragments of a scraper may break off during a cleaning process. In some instances, the fragments of the scraper may fall onto the gas head, build surface or precursor material. For example, a fragment may become lodged in the gas head and may subsequently be dislodged while the gas head is operating above the build surface. As with fusion products ejected from the melt pool onto the build surface, these fragments may disturb the powder bed, may compromise the final built part, or may cause damage to the additive manufacturing system. In some instances, fragments which have fallen onto the build surface may be subjected to laser energy during a subsequent build process. Depending upon the material used for the scraper and the energy level of a laser, the fragments may be vaporized, or they may be fused in with the precursor material. Fusion of the fragments with the precursor material may result in the fragments being included in the final build. In some applications, inclusion of the fragments in the build may result in undesirable material or structural properties in the final built part (e.g., voids, delamination, distortion, etc.), although in other applications, inclusion of the fragments may be acceptable (e.g., when a part is being built to less demanding quality requirements).

In view of the above, it will be appreciated that some materials may be more likely to be vaporized than other materials. For example, a plastic or a polymer may have a lower heat of sublimation or vaporization than a metal or an alloy, causing the plastic or polymer to vaporize at a lower energy level than the metal or alloy. Accordingly, the inventors have recognized and appreciated that in some applications, a material for the scraper may be selected which would be vaporized when it is subjected to the laser energy of the additive manufacturing system. This may reduce the risk that a fragment of the scraper may be fused into or otherwise included in a built part. However, this should not be read to limit the materials available for use in a scraper, as the risks associated with fragments included in the build may vary in different applications. For example, some parts may be built to standards which may tolerate or accept included fragments in the part. Accordingly, any material may be selected which may be suitable for a given application.

In some embodiments, a gas head cleaning device may be sized and shaped to correspond to a geometry of a gas head. A gas head cleaning device may include a scraper that is sized, positioned, and/or oriented to facilitate cleaning of a surface of a gas head, e.g., which is correspondingly sized, positioned, or oriented. Some gas heads may have multiple surfaces which are exposed to ejecta from the melt pool or other emitted materials. For example, emitted materials may be deposited on each of an upper external surface, an upper internal surface, a lower internal surface, and a lower external surface of a gas head during operation of the additive manufacturing system. Accordingly, a gas head cleaning device may include one or more separate scrapers for each surface to be cleaned, including the upper external surface, the upper internal surface, the lower internal surface, the lower external surface, or any other surface of a gas head. Alternately, a scraper may include one or more portions that are configured to remove materials from multiple, differently oriented or positioned surfaces of a gas head.

In addition to including multiple surfaces, some gas heads may include multiple ducts. For example, some gas heads may have two ducts configured to be disposed on opposite sides of a melt pool, such that a flow of gas from one duct to the other may flow across the melt pool. Alternatively, each duct may be associated with a separate flow of gas, such that emitted materials may be entrained in multiple directions away from the melt pool. Multiple ducts may be disposed symmetrically or asymmetrically with respect to a centerline of the gas head, or the ducts may be movable with respect to one another such that the ducts may be configurable in symmetric or asymmetric arrangements. In some embodiments, each duct may have multiple surfaces exposed to emitted materials from the melt pool. Accordingly, a gas head cleaning device may include multiple scrapers. In some embodiments, one or more separate scraper may be provided for each surface of each duct to be cleaned.

In some embodiments, a gas head cleaning device may include a longitudinal shaft with one or more limbs extending from the shaft. Each limb may comprise one or more scraper. A scraper may be formed integrally with a limb, or a scraper may be attachable to a limb such that the scraper may be removed and replaced. In some embodiments, a limb may extend in a radial direction from the longitudinal shaft. Additionally, a limb may extend at an angle with respect to a longitudinal axis of the shaft. In some embodiments, the angle of a limb may be selected to correspond to an angle of a surface of a gas head in order to facilitate cleaning of the surface. In some embodiments, a gas head cleaning device may include a first limb extending from a first side of the shaft, and a second limb extending from a second side of the shaft opposite the first side. In some such embodiments, the first limb may be configured to clean at least one surface of a first duct of a gas head, and the second limb may be configured to clean at least one surface of a second duct of the gas head. In some embodiments, for example when a cleaning device is intended to clean a gas head having symmetrically disposed ducts, the first and second limb may extend from a same point along the longitudinal shaft. Alternatively, in some embodiments, for example when a cleaning device is intended to clean a gas head having asymmetrically disposed ducts, the first and second limb may extend from different points along the longitudinal shaft. It will be appreciated that a gas head cleaning device may include any number of limbs extending in any appropriate direction and from any appropriate point along the longitudinal shaft in order for the limb to clean a corresponding gas head, duct, or surface. It will further be appreciated that a gas head cleaning device or a limb thereof may include any number of scrapers appropriate for cleaning a gas head or any portion or portions thereof.

Because a cleaning device may be in close proximity to a gas head, and may be intended to contact a gas head, the inventors have recognized a risk that contact between a cleaning device and a gas head may damage the cleaning device and/or the gas head. For example, a cleaning device having a shaft and/or a limb formed from a hard metal may dent, scratch, bend, or otherwise damage a gas head if contact is made in an uncontrolled or inadvertent manner. In view of the above, the inventors have recognized and appreciated the benefits of a gas head cleaning device configured to prevent damage to a gas head. In some embodiments, the cleaning device may be formed from a material selected to prevent or reduce damage in the event of inadvertent contact with the gas head. For example, a cleaning device may be formed from a material which is rigid or semi-rigid, but is softer than the material used for the gas head. For example, a cleaning device may be formed from a plastic such as nylon, polyethylene, polyurethane, acrylonitrile butadiene styrene (ABS), polycarbonate (PC), or any other appropriate plastic. Alternatively, a cleaning device may be formed from a semi-rigid or flexible material. For example, a cleaning device may be formed from a softer polymer such as low-density polyethylene (LDPE), thermoplastic polyurethane (TPU), or any other appropriate polymer. In some embodiments, the cleaning device may be configured to be compliant or to fail or break at a lower force than a gas head, in order to reduce a risk of breaking the gas head as a result of contact. For example, the cleaning device may be mounted on a compliant support, such as a flexible shaft or other mount, that allows the cleaning device to give way or otherwise move with contact with a gas head over a threshold force. In some embodiments, a shaft, limb, or other portion of a cleaning device may be formed as a spring or combination of springs to provide a desired flexibility. Although soft and flexible materials are described as reducing a likelihood of damage to a gas head, it will be appreciated that a gas head cleaning device may be formed from any appropriate material, including hard materials such as metals, alloys, ceramics (including sintered ceramics), or composite materials (e.g., carbon fiber, glass filled nylon or other polymer, etc.). For example, a cleaning device may be formed from brass, copper, aluminum, nickel, steel, titanium, or any other appropriate metal or alloy.

Further, the inventors have appreciated that a scraper, such as a brush or a blade, being passed along a surface of a gas head during a cleaning operation may produce a degree of static electricity. If left to accumulate, static electricity may disrupt a build, for example by attracting or disturbing a powdered precursor material on a build surface. In view of the above, the inventors have recognized and appreciated the benefits of a gas head cleaning device configured to discharge static electricity. In some embodiments, a gas head cleaning device may be electrically grounded within an additive manufacturing system. Additionally or alternatively, a cleaning device may be formed from a material that is electrically conductive. For example, in some embodiments, a cleaning device may include at least a portion formed from a conductive metal (e.g., copper, aluminum, gold, or others), a conductive composite (e.g., carbon fiber or others), or a suitable plastic, resin, or polymer (e.g., a static dissipative plastic, resin, or polymer which includes conductive fibers, particles, or materials, including those which may be suitable for additive manufacturing such that the cleaning device may be formed by additive manufacturing from a static dissipative material). The cleaning device may be grounded or otherwise electrically connected to a suitable potential to remove static charge or otherwise expose the gas head surface to an electric potential to help remove emitted materials and/or avoid disruption to a build process.

It will be appreciated that the methods disclosed herein may be performed at any appropriate time. For example, a cleaning operation may be performed before, during, or after a part is built. Additionally, a cleaning operation may be performed at any appropriate time during a build operation. In some embodiments, a cleaning operation may be performed between build layers, for example while a recoating system is depositing the next layer of precursor material on a build surface. The cleaning operation may be performed at any appropriate interval, for example after every layer, after every other layer, or at any other appropriate interval. In some embodiments, one or more sensors such as a camera, an optical sensor, a weight sensor, or any other appropriate sensor may be configured to detect an accumulation of debris on a surface of a gas head. When a sufficient volume or mass of debris is detected by the sensor(s), the system may initiate a cleaning operation. For example, a controller or processor may be operatively coupled to the sensor(s) and to portions of the system which actuate the gas head, the cleaning device, and/or any other appropriate portion of the system.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

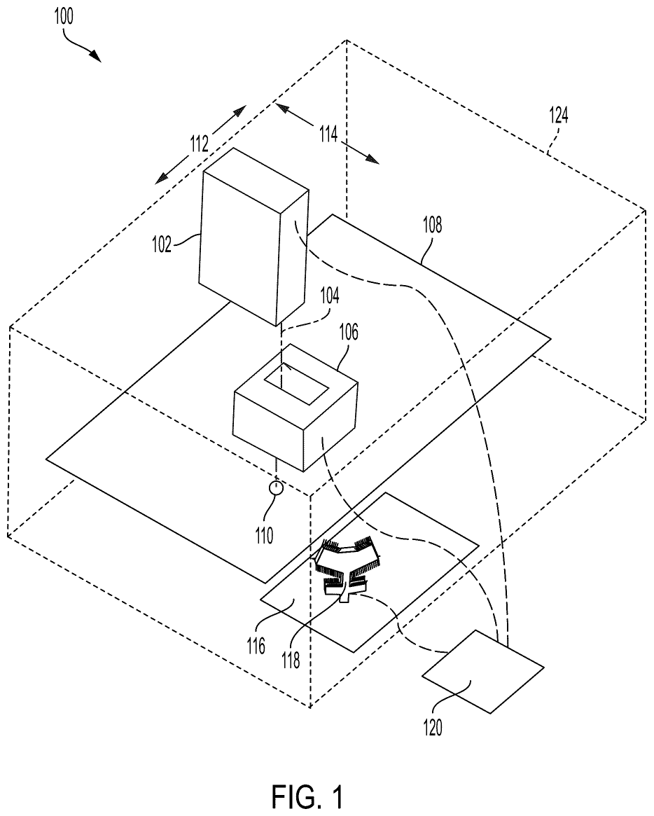

FIG. 1 depicts one embodiment of an additive manufacturing system 100. The additive manufacturing system 100 may comprise a build volume 124. The build volume 124 may contain an optics assembly 102, which may direct one or more laser beams 104 through a gas head 106 and onto a build surface 108. The incident laser beam(s) 104 may produce one or more melt pools 110 on the build surface 108. The position of the melt pool 110 on the build surface may be controlled by moving the optics assembly 102 along directions 112 and 114 relative to the build surface, for example using motion stages, a gantry system, or any other appropriate method or mechanism. Embodiments in which galvanometers, mirrors (i.e., galvomirrors) or other appropriate methods and systems for moving the laser beam(s) relative to the build surface and gas head are also contemplated as the disclosure is not limited in regard to the methods or systems for directing the laser energy or laser beam(s). The gas head 106 may be provided to entrain and remove ejecta, fusion products, or other emitted materials from the melt pool 110 and/or other portions of the build surface. The gas head 106 may be moveable relative to the build surface 108, for example using motion stages, a gantry system, or any other appropriate method or mechanism, such that the gas head may remain in the area of the melt pool as the laser energy is scanned across the build surface 108.

The additive manufacturing system 100 may further include a gas head cleaning device 118 disposed in a cleaning area 116 of the system 100. The cleaning area 116 may be adjacent to and/or separate from the build surface 108, such that debris which is cleaned from or which falls from the gas head 106 may fall into the cleaning area 116 without disturbing the precursor material disposed on the build surface. The cleaning device 118 may include one or more scrapers configured to clean one or more surfaces of the gas head 106. Further, the cleaning device 118 may be operatively coupled to at least one actuator to move or rotate the cleaning device within the cleaning area, for example in preparation for a cleaning operation, as part of a cleaning operation, or subsequent to a cleaning operation.

In some embodiments, an additive manufacturing system 100 may include one or more controllers 120. A controller may be operatively coupled with and control one or more controllable portions of the optics assembly 102, the gas head 106, the gas head cleaning device 118, a gantry system, and/or any other portion of the additive manufacturing system. This may include various components such as actuators, valves, gas flow generators, vacuum sources, pressurized gas sources, and/or any other appropriate component. In some embodiments, a controller may include one or more processors and associated non-transitory computer readable memory. The memory may include computer readable instructions that when executed by the one or more processors cause the additive manufacturing system to perform any of the methods and processes disclosed herein.

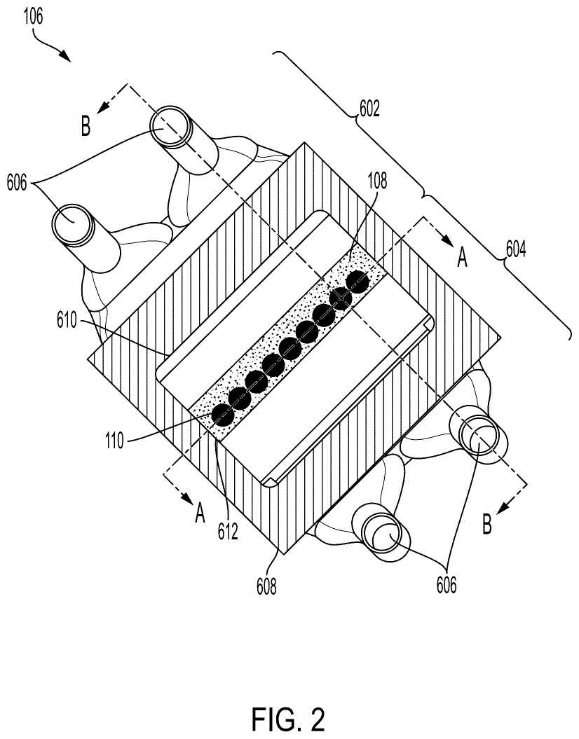

FIG. 2 depicts a top view of a gas head 106 according to some embodiments. The gas head may have an upper portion 608 having a window or aperture 610 to allow laser energy from an optics assembly to be directed through or past the gas head 106 towards a build surface 108, or towards a precursor material disposed on the build surface. The gas head may further include a first duct 602 on a first side and a second duct 604 on a second side. Each duct may be fluidly coupled to a vacuum source, fan, air pump, or other gas flow generator (not shown) via one or more gas outlets 606. The first and second ducts 602, 604 may be spaced apart from each other, with a gap 612 between the ducts allowing laser energy from an optics assembly to be directed through or past the gas head 106. When the precursor material is subjected to the laser energy, one or more melt pools 110 may be formed on the build surface 108. In some embodiments, the melt pools 110 may be formed on or along a centerline A-A of the gas head 106. Each of the first and second ducts 602, 604 may be disposed adjacent to the melt pools 110 to entrain or remove fusion products, ejecta, or other emitted materials. When a vacuum source or air flow generator is activated, a flow of gas may be drawn at or near the melt pools 110 and into a duct to entrain emitted materials. In some embodiments, each duct may be offset from the centerline A-A and/or from the melt pool(s) 110. In some embodiments, the ducts may be disposed symmetrically such that the first and second ducts 602, 604 are offset about the same distance from the centerline A-A. In some embodiments, the ducts may be disposed asymmetrically such that the first and second ducts 602, 604 are offset different distances from the centerline A-A, in order to entrain a greater proportion or volume of emitted materials from a side which is closer to the melt pools. In further embodiments, the ducts may be moveable and controllable such that the first and second ducts 602, 604 may be selectively arranged symmetrically or asymmetrically. In the embodiment shown, the second duct 604 may be disposed at a shorter distance from the centerline A-A and the melt pools 110 than the first duct 602.

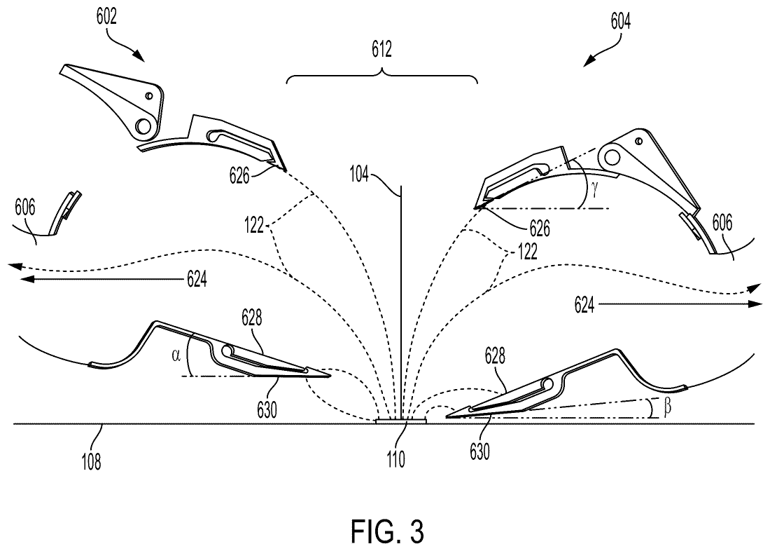

FIG. 3 depicts a cross-section of the first duct 602 and the second duct 604 taken along the line B-B of FIG. 2. In the depicted embodiment, the first and second ducts 602, 604 may be on opposite sides of a melt pool 110 formed by the incidence of laser energy 104 on a precursor material disposed on the build surface 108. As noted above, the second duct 604 may be closer to the melt pool 110 than the first duct. Additionally, it can be seen from FIG. 3 that the second duct 604 may be disposed at a shorter distance from the build surface 108 than the first duct 602. Accordingly, the second duct 604 may be in an extended configuration, wherein the second duct may be disposed at a shorter distance from the build surface and/or the melt pool than the first duct. Additionally, the first duct 602 may be in a retracted configuration, wherein the first duct may be disposed at a greater distance from the build surface and/or the melt pool than the second duct.

Because each duct is disposed at different distances from the melt pool(s) and from the build surface (i.e., the first duct is in a retracted configuration and the second duct is in an extended configuration), the gas head 106 may be in an asymmetric configuration. As will be shown, a gas head cleaning device according to the present disclosure may be arranged in a correspondingly asymmetric configuration. However, it will be appreciated that a gas head may alternatively be provided in a symmetric configuration in which a first and second duct may be offset the same distance from a centerline and from a build surface. Accordingly, a gas head cleaning device may be arranged in a correspondingly symmetric configuration.

The incidence of laser energy on the build surface 108 may fuse a portion of the precursor material disposed on the build surface. This fusion process may cause rapid phase changes (e.g., liquification and/or gasification) in the precursor material, which may result in emitted materials 122 being emitted from the melt pool 110 or otherwise at the build surface. The emitted materials 122 may comprise individual powder particles, partially fused powder particles, molten droplets, cooled molten droplets, fumes, and/or any other form of matter or ejecta that may result from laser fusion of a precursor material. After ejection from the melt pool 110, at least a portion of the emitted materials 122 may be entrained by a flow of gas 624 through the gas head or through a duct of the gas head. Some of the entrained emitted materials may be carried out of the gas head through a gas outlet 606. However, as noted above, some emitted materials may adhere to or be deposited onto a surface of the gas head. In some instances, emitted materials may adhere to a surface of a duct of the gas head, including an internal surface and/or an external surface of the duct. For example, emitted materials 122 may adhere to an upper internal surface 626 of a duct, a lower internal surface 628 of the duct, a lower external surface 630 of the duct, and/or any other surface of a duct, including an upper external surface of a duct.

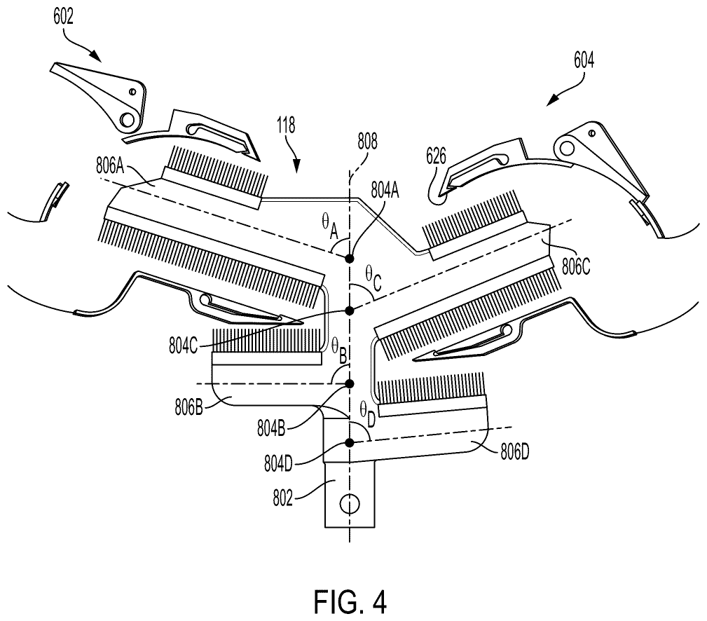

As will be appreciated with reference to FIG. 3, a duct or a surface of a duct may be disposed at an angle with respect to the build surface. For example, a lower internal surface 628 may be disposed at a first surface angle α with respect to the build surface 108, a lower external surface 630 may be disposed at a second surface angle ß with respect to the build surface 108, and an upper internal surface 626 may be disposed at a third surface angle γ with respect to the build surface. Accordingly, a gas head cleaning device according to the present disclosure may include a scraper disposed at an angle which may correspond to an angle of a duct surface. FIG. 4 depicts one embodiment of a gas head cleaning device including such an arrangement.

In the embodiment of FIG. 4, a gas head cleaning device 118 may comprise a longitudinal shaft 802. The longitudinal shaft 802 may extend along a longitudinal axis 808 of the cleaning device. One or more limbs may extend from the longitudinal shaft. Each limb may be configured to clean a surface of a gas head or a duct thereof. In some embodiments, each limb may extend in a direction and/or from a point along the longitudinal shaft which places the limb in an appropriate position along the shaft to clean a corresponding surface. Additionally or alternatively, each limb may extend at an angle relative to the shaft or the longitudinal axis which places the limb at an appropriate orientation to clean the corresponding surface.

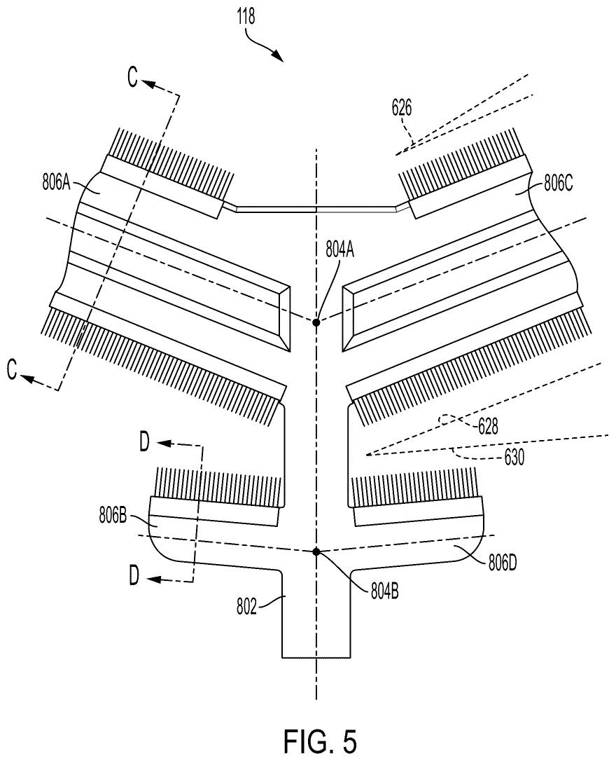

In various embodiments, the one or more limbs may extend from various points along the longitudinal shaft. In some embodiments, multiple limbs may extend from multiple points along the shaft. For example, the gas head cleaning device 118 may comprise a first limb 806A extending from a first point 804A along the longitudinal shaft, a second limb 806B extending from a second point 804B, a third limb 806C extending from a third point 804B, and a fourth limb 806D extending from a fourth point 804B. In some embodiments, each point 804A-D may be disposed at a different point along the longitudinal shaft such that each limb extends from a different point along the shaft. For example, when a gas head cleaning device is configured to clean a gas head while the gas head is in an asymmetric configuration, each limb may extend from a different point along the shaft as shown in FIG. 4. However, some embodiments may include multiple limbs extending from a single point along the shaft. For example, when a gas head cleaning device is configured to clean a gas head while the gas head is in a symmetric configuration, multiple limbs may extend in different directions from the same point. One such configuration is shown below in FIG. 5.

Additionally, each of the one or more limbs may extend in any appropriate direction from the longitudinal shaft. In some embodiments, multiple limbs may extend in multiple directions from the shaft. In some embodiments in which the gas head cleaning device is configured to clean two opposing ducts of a gas head, two or more limbs may extend in two opposing directions. For example, the gas head cleaning device 118 may comprise a first limb 804A extending in a first direction from the longitudinal shaft, a second limb 804B extending in the first direction, a third limb 804C extending in a second direction, and a fourth limb 804D extending in the second direction. Alternatively, in some embodiments in which the gas head cleaning device is configured to clean a single duct of a gas head, one or limbs may extend from a single direction. It is also contemplated that any appropriate number of limbs may extend in any direction or directions in order to clean any appropriate number of surfaces or ducts of a gas head, which may be disposed in any appropriate arrangement.

Further, the one or more limbs may extend at any appropriate angle from the longitudinal shaft. In some embodiments, multiple limbs may extend at different angles from the shaft. For example, a gas head cleaning device 118 may comprise a first limb 804A extending at a first limb angle θ_{A} from the longitudinal shaft, a second limb 804B extending at a second limb angle θ_{B}, a third limb 804C extending at a third limb angle θ_{C}, and a fourth limb 804D extending at a fourth limb angle θ_{D}. Each limb angle θ_{A-D} may be selected to position the corresponding limb at an appropriate angle for cleaning a surface of a gas head. For example, each limb angle θ_{A-D} may be selected to correspond to an angle at which the surface of the gas head is disposed (e.g., surface angles α, β, γ of FIG. 3, or any other appropriate angles). It will be appreciated that a limb angle may correspond to a surface angle without the two angles being equal. For example, in various embodiments, a limb angle may be complementary, supplementary, or equal to a surface angle, or may have any appropriate relationship or correspondence to a surface angle.

In view of the above, it will be appreciated that a limb angle may be any appropriate angle. In some embodiments, a limb angle may be greater than or equal to 45°, 55°, 65°, 70°, and/or any other appropriate angle. Additionally, a limb angle may be less than or equal to 90°, 85°, 75°, 70°, and/or any other appropriate angle. Combinations of the foregoing at also contemplated, including, for example, greater than or equal to 45° and less than or equal to 90°, greater than or equal to 65° and less than or equal to 75°, greater than or equal to 80° and less than or equal to 90°, and/or any other appropriate combination of the foregoing. Of course, while particular ranges for the limb angle are provided, it will be appreciated that other ranges both great than and less than those noted are also contemplated as the disclosure is not limited in this regard.

FIG. 5 depicts one embodiment of a gas head cleaning device in which multiple limbs may extend from a same point along the longitudinal shaft. In some embodiments, a first limb 806A and a third limb 806C may extend from a first point 804A along the longitudinal shaft 802, and a second limb 806B and a fourth limb 806D may extend from a second point 804B along the shaft. In some embodiments, the first limb 806A and the second limb 806B may extend in a first direction from the shaft, and the third limb 806C and the fourth limb 806D may extend in a second direction. In various embodiments, the first and second directions may be different directions, or the first and second directions may be opposite directions. In some embodiments, two or more limbs may extend from a same point along the longitudinal shaft to facilitate cleaning of two ducts which are disposed symmetrically in the gas head. Alternatively, two or more limbs may extend from a same point along the longitudinal shaft to facilitate cleaning of two ducts which are moveable between an extended configuration and a retracted configuration, as described above. For example, in FIG. 5, a first duct may be out of the image in a retracted configuration away from the cleaning device, while a second duct may be in an extended configuration such that the upper internal surface 626, the lower internal surface 628, and/or the lower external surface 630 may be in close proximity to or in contact with respective limbs or scrapers of the cleaning device. It will be appreciated that, in some embodiments, the second duct may be cleaned by the third limb 806C and the fourth limb 806D while the second duct is in the extended configuration as shown, and that the first duct may be moved to the extended configuration in order to clean the first duct using the first limb 806A and the second limb 806B. In some embodiments, the second duct may be moved into a retracted configuration when the first duct is moved into the extended configuration.

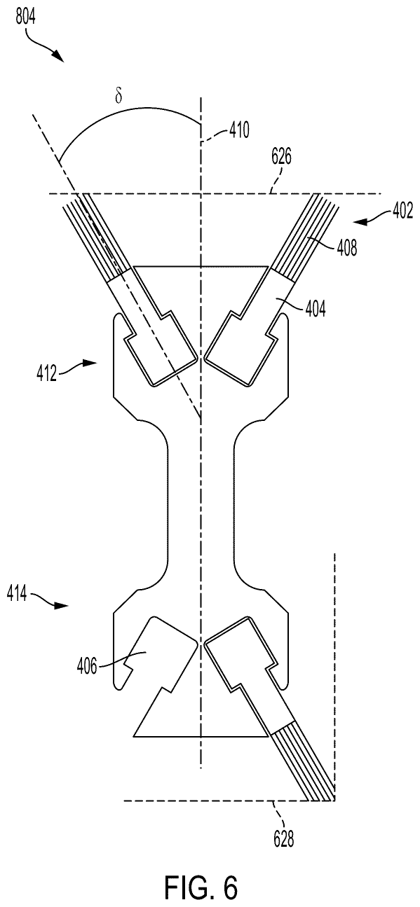

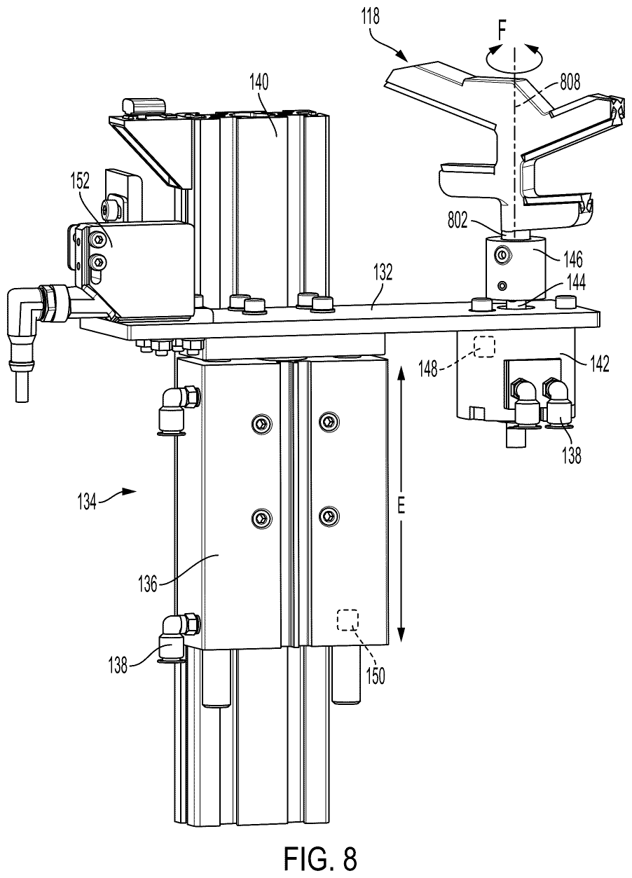

FIG. 6 shows a cross-sectional view of a limb of some embodiments of a gas head cleaning device, for example as taken along line C-C of FIG. 5. In the cross-sectional view, it can be seen that a limb 804 may include a plurality of scrapers 402. In some embodiments, each scraper 402 may be removably coupled to the limb 804. For example, a limb may be configured to slidably receive a scraper or a portion of a scraper. In FIG. 6, one of the scrapers has been removed for illustrative purposes. For example, each scraper may have a coupling root 404 configured to be selectively insertable and removable or slidable into and out of a corresponding slot 406 of the limb 804. A slot 406 may extend along a length of the limb, for example in a radial direction relative to the longitudinal axis of the gas head cleaning device (the length of the slot in some embodiments is best seen in FIG. 8). A scraper may include a debris separator 408 extending from the coupling root. The debris separator 408 may be configured to scrape, dislodge, clean, separate, or otherwise remove fusion products, ejecta, or other emitted material from a gas head. In various embodiments, the debris separator 408 may be a brush, a blade, an edge, a nozzle of an air jet or air blade, a scouring pad, or any other appropriate mechanism for cleaning or removing debris from a surface. For example, as seen in FIG. 6, a debris separator 408 may comprise a brush or a set of bristles configured to clean a surface of a gas head. As noted above, a brush or bristles may be formed from any appropriate material, including any appropriate plastic, polymer, metal, alloy, composite, or any other material.

In some embodiments, a scraper or slot may be disposed at an angle with respect to a central plane or axis of the limb. For example, in FIG. 6, the slot 406 and/or the scraper 402 may be disposed at a scraper angle δ with respect to the central plane 410 of the limb 804, such that the scraper 402 and/or the debris separator 408 may be disposed at a corresponding angle with respect to the central plane. The angled disposition of a scraper may facilitate cleaning of a gas head surface by increasing a range of coverage or contact footprint of the gas head cleaning device and/or by enabling the scraper to extend into a corner of a gas head. For example, a scraper of FIG. 6 may extend into a corner at one end of a lower internal surface 628 of a gas head or a duct of a gas head.

It will be appreciated that a scraper angle may be any appropriate angle. In some embodiments, a scraper angle may be greater than or equal to 10°, 15°, 25°, 30°, and/or any other appropriate angle. Additionally, a scraper angle may be less than or equal to 60°, 45°, 30°, 25°, and/or any other appropriate angle. Combinations of the foregoing at also contemplated, including, for example, greater than or equal to 10° and less than or equal to 60°, greater than or equal to 25° and less than or equal to 30°, greater than or equal to 15° and less than or equal to 25°, and/or any other appropriate combination of the foregoing. Of course, while particular ranges for the scraper angle are provided, it will be appreciated that other ranges both great than and less than those noted are also contemplated as the disclosure is not limited in this regard.

In some embodiments, a limb may include one or more scrapers configured to clean a single surface of a gas head. Additionally, two or more scrapers of a limb may each be configured to clean a different surface of a gas head. In some embodiments, the scrapers may be configured to clean the different surfaces concurrently. For example, in FIG. 6, the limb 804 may include two scrapers extending from a first side 412 of the limb configured to clean an upper internal surface 626 of a duct of a gas head, as well as two scrapers extending from a second side 414 of the limb configured to clean the lower internal surface 628. Such arrangements may enable the scrapers on the first side to clean the upper internal surface while the scrapers on the second side clean the lower internal surface to reduce a time required to complete a cleaning operation. In other embodiments, a limb may include any appropriate number of scrapers extending from any appropriate portion of the limb configured to clean any appropriate surface of a gas head, as the disclosure is not limited in this regard.

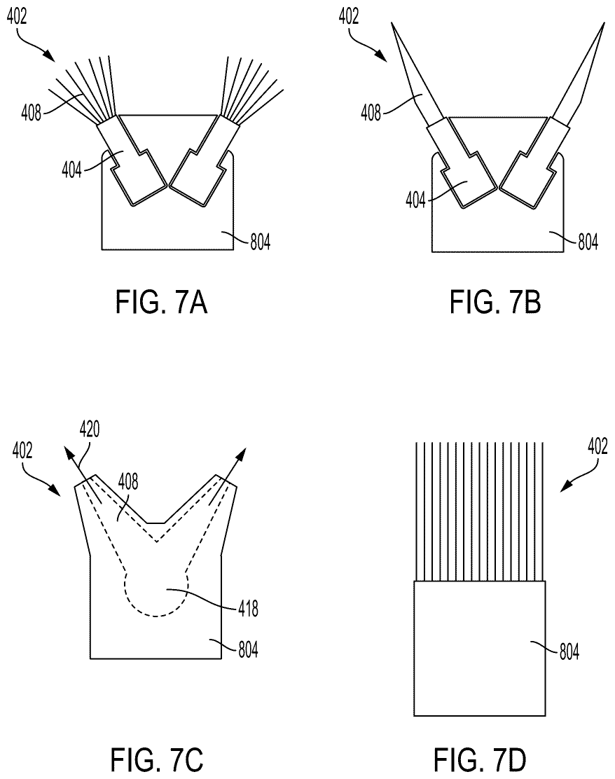

FIGS. 7A-7D depict cross-sectional views of limbs and scrapers according to various embodiments of a gas head cleaning device, for example as taken along line D-D of FIG. 5. It will be noted that, in contrast with the limb of FIG. 6, the limbs of FIGS. 7A-7D may be configured to clean only a single surface, for example a lower external surface of a gas head or a duct of a gas head. As seen in FIG. 7A, a scraper or a debris separator thereof may include bristles which fan out at any appropriate angle, for example to increase a coverage footprint of a scraper. As seen in FIG. 7B, a scraper or a debris separator thereof may include a blade configured to scrape or dislodge debris from a surface. As noted above, the blade may be any appropriate material, including any appropriate plastic, polymer, metal, alloy, composite, ceramic, or any other material.

As seen in FIG. 7C, a scraper or a debris separator thereof may comprise an air scraper 408 such as an air jet or an air blade. In some embodiments, an air scraper may be fluidly coupled to gas supply, for example a pressurized gas source. A channel 418 may be formed in the limb 804 and/or in the longitudinal shaft of the cleaning device to provide fluid communication between the air scraper 408 and the air supply. In some embodiments, an air scraper may be formed as one or more discrete air jets disposed along at least a portion of a length of the limb, each air jet comprising a conical nozzle in fluid communication with the channel 418 and configured (e.g., positioned and/or oriented) to direct a jet of gas 420 towards a surface to be cleaned. In some embodiments, an air scraper may be formed as an air blade comprising a single nozzle extending along at least a portion of a length of the limb in fluid communication with the channel 418 and configured (e.g., positioned and/or oriented) to direct a jet of gas towards a surface to be cleaned. As seen in FIG. 7D, a scraper may be formed integrally with the limb or other portion of the cleaning device. For example, a limb 804 may include a scraper 402 comprising a brush or a set of bristles extending directly from the limb 804, rather than from a coupling root as described above.

It will be appreciated that in some embodiments, a scraper may comprise any appropriate mechanism for cleaning a surface of a gas head, as the disclosure is not limited to those embodiments depicted herein. For example, in some embodiments, a debris separator may comprise a rotary brush configured to remove debris by rotating about an axis of the rotary brush. The rotary brush may be driven by any appropriate power source, including any appropriate motor or actuator. In some embodiments, a scraper may be moveable relative to a limb or other support on which the scraper is mounted, e.g., the scraper may rotate about an axis parallel or otherwise oriented to a limb or other support, may move linearly along an axis parallel or otherwise oriented to a limb or other support, etc.

In operation, a gas head cleaning device may be used, actuated, controlled, or otherwise employed to clean a gas head or a surface thereof in any appropriate way. In some embodiments, the gas head cleaning device may be statically disposed, and the gas head may be moved relative to the cleaning device in order to clean the gas head. In some embodiments, the cleaning device may be moveable, such that the gas head may remain static while the cleaning device moves relative to the gas head in order to clean the gas head. In some embodiments, both the cleaning device and the gas head may be moveable, and both the cleaning device and the gas head may move relative to one another in order to clean the gas head. Moreover, one or more surfaces may be cleaned simultaneously and/or sequentially by a cleaning device by a same or different scrapers.

FIG. 8 depicts one embodiment of an additive manufacturing system in which a gas head cleaning device is configured to move. In some embodiments, the gas head cleaning device may be provided in conjunction with, installed onto, or otherwise operatively coupled to a motion stage 132. The motion stage 132 may facilitate movement of the cleaning device 118 by coupling the cleaning device to one or more actuators. However, it will be appreciated that a cleaning device may alternatively be coupled directly to a linear actuator. In FIG. 8, the motion stage 132 may be attached to a linear actuator 134 configured to drive the motion stage 132 and/or the cleaning device 118 in at least one direction, as indicated by arrow E. In embodiments, a linear actuator may comprise any motor or actuating mechanism appropriate for translating a gas head cleaning device in at least one linear direction. For example, a linear actuator may comprise an electric or pneumatic motor or actuator, a brushless motor, a servo motor, a spindle motor, or any other appropriate motor or actuator. In FIG. 8, the linear actuator 134 may comprise a pneumatic actuator 136 fluidly coupled to a pressurized fluid source via one or more pneumatic couplings 138. Selective pressurization of a pneumatic fluid may move the motion stage 132 in either of the directions indicated by arrow E by driving the pneumatic actuator 136 along one or more linear rail 140. A processor or controller of an additive manufacturing system may be in operative communication with the pneumatic system to move the gas head cleaning device in the directions of arrow E.

In some embodiments, a linear actuator may be configured to move a cleaning device between a storage position and a cleaning position. For example, a cleaning device may be in a storage position when it is below a build surface, such that a gas head, optics assembly, or other component may move above the build surface without colliding with the cleaning device. A cleaning device may be in a cleaning position when it is above the build surface, such that a gas head may be moved to come into contact with the cleaning device. In some embodiments, the cleaning device may be movable between the storage and cleaning positions in a cleaning area of a build volume. Additionally, in some embodiments, moving the cleaning device between the storage position and the cleaning position may comprise moving the cleaning device in a linear direction, for example using a linear actuator 134 to move the cleaning device in direction(s) E. However, it will be appreciated that in some embodiments, moving the cleaning device between a storage position and a cleaning position may comprise rotating the cleaning device in addition to or instead of translating the cleaning device.

In some embodiments, a gas head cleaning device may be operatively coupled to at least one rotational actuator. In some embodiments, a gas head cleaning device 118 may be rotationally coupled to a motor or actuator such that the motor or actuator may rotate the cleaning device in at least one direction. For example, a rotational actuator 142 may be installed onto or attached to a motion stage 132. The rotational actuator 142 may be coupled to the gas head cleaning device 118 in order to rotate the cleaning device, for example to rotate the cleaning device 118 about its longitudinal axis 808. In some embodiments, a drive shaft 144 of the rotational actuator may be coupled to the longitudinal shaft 802. In some embodiments, a collar 146 may couple the drive shaft 144 to the longitudinal shaft 802 such that the two shafts are substantially coaxial. In some embodiments, the collar 146 may be coupled to one or both shafts using a set screw, a pin insertable into a hole of the shaft, a snap fit, press fit, or interference fit, or any other appropriate coupling. In some embodiments, the collar may be integrally formed as a portion of a shaft, for example as a portion of the longitudinal shaft of the cleaning device or as a portion of the drive shaft, such that only one shaft must be coupled with the collar.

In embodiments, a rotational actuator may comprise any motor or actuating mechanism appropriate for rotating a gas head cleaning device in at least one rotational direction. For example, a rotational actuator may comprise an electric or pneumatic motor or actuator, a brushless motor, a servo motor, a spindle motor, or any other appropriate motor or actuator. In FIG. 8, the rotational actuator 142 may comprise a pneumatic actuator fluidly coupled to a pressurized fluid source via one or more pneumatic couplings 138. Selective pressurization of a pneumatic fluid may rotate the drive shaft 144 in either of the directions indicated by arrow F. A processor or controller of an additive manufacturing system may be in operative communication with the pneumatic system to rotate the gas head cleaning device in the directions of arrow F. Movement of the cleaning device can cause the cleaning device to be suitably positioned relative to a gas head for cleaning, e.g., so the gas head can be moved relative to the cleaning device, and/or can cause the cleaning device to move relative to the gas head for contact with gas head surfaces and removal of emitted materials.

An additive manufacturing system may additionally include at least one sensor or monitor to detect a position of various components of the additive manufacturing system, or to detect relative positions of multiple components. In some embodiments, the system may include at least one gas head sensor configured to detect a position, orientation, and/or configuration of a gas head within a build volume of the system and/or at least one cleaning device sensor configured to detect a position, orientation, and/or configuration of a gas head cleaning device within the build volume. Alternately, or in addition, a sensor may be employed to determine relative position and/or movement of a gas head and cleaning device, e.g., to prevent collisions or other unwanted contact between the two. In some embodiments, a sensor may be included within or on, or otherwise provided in conjunction with, an actuator of the system and/or the gas head cleaning device. For example, the rotational actuator 142 may include a rotary sensor 148. The rotary sensor 148 may be configured to detect a rotational movement, rotational position, and/or angular orientation of the drive shaft 144, which may be indicative of a rotational movement, rotational position, and/or angular orientation of the gas head cleaning device 118. Additionally or alternatively, the lincar actuator may include a position sensor 150. The position sensor 150 may be configured to detect a position of the linear actuator or the motion stage 132 along the rail 140, which may be indicative of a linear position of the cleaning device 118 along the direction of arrow E. Additionally, in some embodiments, the system may include a sensor to detect or monitor a position, orientation, and/or configuration of a gas head of the system. For example, a gas head sensor 152 may be included to detect a position of the gas head. In some embodiments, the gas head sensor 152 may comprise an optical sensor, including a laser position sensor, a camera, or other optical sensor, or the gas head sensor may comprise a proximity sensor, or any other appropriate type of sensor or combination of sensors.

In some embodiments, a controller or processor of the additive manufacturing system may be in data communication with the one or more sensors of the system. For example, a sensor may transmit data indicative of a position or orientation of a component of the system (e.g., data indicative of a position or orientation of a cleaning device, a motion stage, a gas head, or any other component). In some embodiments, the controller or processor may actuate or control a motor or actuator of the system to move a component coupled to the motor or actuator, as described above, based at least in part on the data indicative of the position or orientation of the component or data indicative of other components. In some embodiments, the controller or processor may use the position or orientation data to prevent or avoid collisions between components, for example to prevent or avoid collisions between a gas head and a gas head cleaning device.

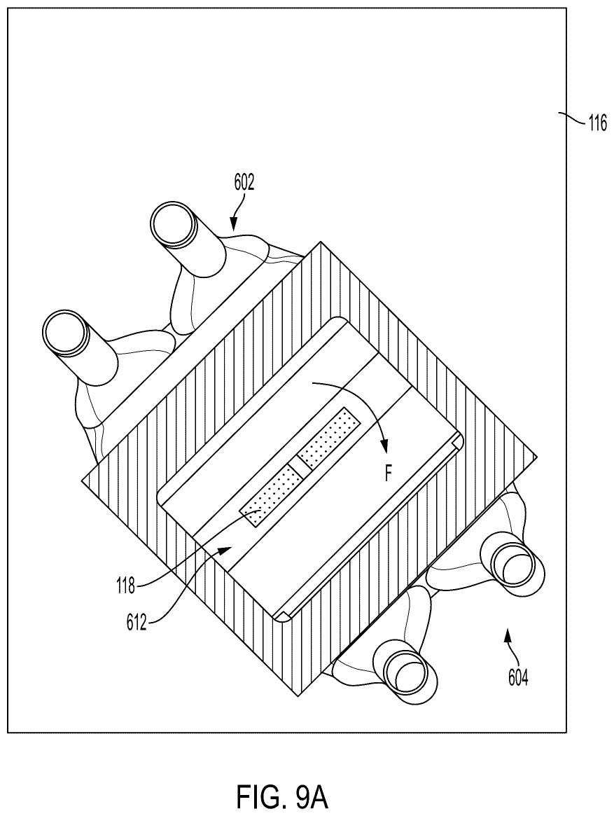

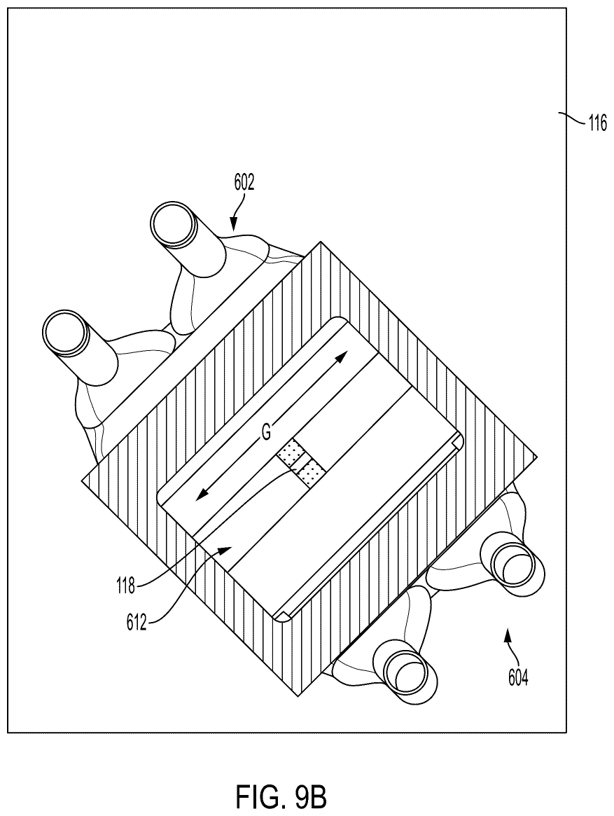

As shown in FIG. 9A, a gas head 106 may be moved or positioned relative to a gas head cleaning device 118 prior to or during a gas head cleaning operation. For example, the gas head 106 may be moved into a cleaning area 116 of an additive manufacturing system so that the risk of disturbing or contaminating a precursor material or powder bed may be reduced during the cleaning operation. In some embodiments, both the gas head and the gas head cleaning device may be moved into a cleaning area or other area suitable for cleaning the gas head. For example, the gas head cleaning device may be stored in a storage area and moved into a cleaning area prior to or during a cleaning operation. In some embodiments, the gas head 106 may be moved to a position above the cleaning device 118. The cleaning device 118 may be rotated to a position wherein the cleaning device aligns with a gap 612 of the gas head. For example, the cleaning device 118 may be rotated to a position wherein the device aligns with a gap 612 between a first duct 602 and a second duct 604 of the gas head, such that when the gas head is lowered with respect to the cleaning device, the first and second ducts are moved to positions on opposing sides of the cleaning device without contacting the cleaning device. It should be appreciated that the relative positioning of the gas head and the cleaning device may be selected based on any appropriate feature or combination of features of any given symmetric or asymmetric configuration. For example, the gas head cleaning device may be moved or rotated to a position where the cleaning device aligns with a top surface of the gas head or a duct thereof. Additionally or alternatively, the relative positioning may be based, at least in part, on a location of a laser beam emitted from an optics assembly to which the gas head may be coupled.

In some embodiments, when the first and second ducts are positioned on opposing sides of the cleaning device, one or more scrapers of the cleaning device may be moved to a position and/or an orientation which corresponds to a position or orientation of a surface of the gas head or a duct of the gas head. For example, the cleaning device 118 may be rotated in the direction F as shown in FIG. 9A, such that one or more scrapers are positioned and oriented to clean respective surfaces of a duct of the gas head 106. For example, in some embodiments, rotation of the cleaning device 118 in the direction F may place the cleaning device in the position shown in FIG. 4. However, it will be appreciated that FIG. 4 depicts only one arrangement, and that a cleaning device and gas head may be positioned or arranged relative to one another in any appropriate manner, as the disclosure is not limited with respect to the relative positions or orientations of the cleaning device and the gas head. For example, in some embodiments, a cleaning device may be lowered or raised into a gap, space, or volume of a gas head, and the cleaning device may not require rotation to be in position for a cleaning operation.

In some embodiments, when the cleaning device 118 and the gas head 106 are in position for a cleaning operation, one or both components may be moved in at least one direction so that a scraper of the cleaning device is passed along a surface of the gas head. For example, in some embodiments, the gas head 106 may be moved in a linear direction as indicated by arrow G in FIG. 9B. In some embodiments, the cleaning device 118 may be held stationary while the gas head moves in the direction(s) G and/or in direction(s) transverse to direction G. In some embodiments, the gas head and the cleaning device may be moved in opposite directions to reduce a time required for a cleaning operation. In some embodiments, a gas head may be held stationary while the cleaning device is moved in the direction(s) G.

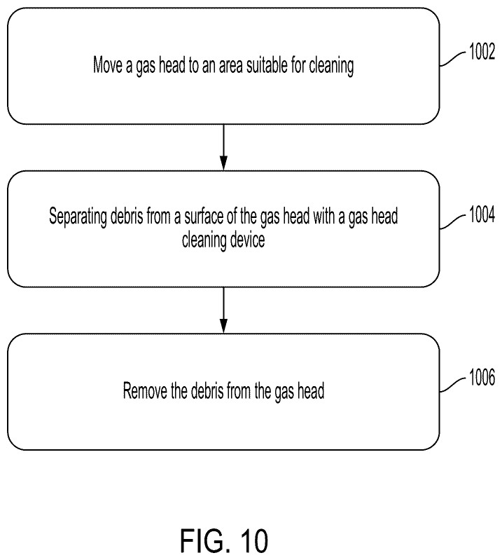

FIG. 10 depicts a flow chart illustrating a method of cleaning a gas head of an additive manufacturing system. At step 1002, the method may comprise moving the gas head to an area of the additive manufacturing system suitable for cleaning the gas head. This step may comprise moving the gas head to a cleaning area of the additive manufacturing system. As noted above, the cleaning area may be adjacent to and/or separate from a build surface of the system, such that debris cleaned from the gas head may fall into the cleaning area without disrupting a precursor material. Further, moving the gas head may comprise actuating a gantry system or other actuation system associated with the gas head. Additionally, this step may include moving the gas head cleaning device to the cleaning area instead of or in addition to moving the gas head.

At step 1004, the method may comprise separating debris from a surface of the gas head with a gas head cleaning device of the system. This step may include dislodging debris from the surface using a brush, a blade, an air jet, an air blade, or a scouring pad. The gas head cleaning device may be any embodiment of a cleaning device as described herein. Separating debris may include separating debris from an internal surface of the gas head, such as an upper internal surface and/or a lower internal surface, and/or an external surface of the gas head, such as an upper external surface and/or a lower external surface. It will be appreciated that this step is not limited to cleaning any particular surface or any single surface, and that any appropriate surface or combination of surfaces may be cleaned.

Further, step 1004 may include separating debris from different surfaces using different scrapers of the cleaning device. For example, debris may be separated from a first surface using a first scraper, and debris may be separated from a second surface using a second scraper. In various embodiments, the first and second surface may be on the same duct or different ducts of a gas head. For example, in some embodiments, the first surface may be on a first duct and the second surface may be on a second duct. In some embodiments, the first duct may be moved from an extended configuration to a retracted configuration to space the first duct or the first surface apart from the first scraper, and the second duct may be moved from a retracted configuration to an extended configuration to place the second scraper in contact with the second surface.

In various embodiments, debris may be separated from the first and second surfaces simultaneously or sequentially. For example, in some embodiments, debris may be separated from the first and second surfaces simultaneously. In other embodiments, debris may be separated from the first and second surfaces sequentially, such that only one duct or only one surface is being cleaned at a time, whether by a same scraper or different scraper.

Step 1004 may further include moving the gas head cleaning device from a storage position below a build surface of the additive manufacturing system to a cleaning position above the build surface. A scraper may be engaged with a surface of the gas head, and the gas head may be moved in at least one direction to pass the scraper along the surface of the gas head. Moving the cleaning device from the storage position to the cleaning position may include translating the cleaning device in a linear direction. For example, as shown in FIG. 8, the cleaning device may be moved from the storage position to the cleaning position by actuating the linear actuator 134 to move the cleaning device in the direction of arrow E. This may result in at least a portion of the cleaning device being moved into a gap between to ducts of the gas head. Additionally, engaging the scraper of the cleaning device with the surface may include rotating the cleaning device to place the scraper in contact with the surface. With further reference to FIG. 8, the scraper may be engaged with the surface of the gas head by, for example, rotating the cleaning device about its longitudinal axis in the direction of arrow F. With reference to FIG. 9B, the gas head may be moved in direction(s) G in order to pass the scraper along the surface.

At step 1006, the debris may be removed from the gas head. In some embodiments, a flow of gas may be created through the gas head, and at least a portion of the debris may be entrained in the flow of gas to remove it from the gas head. Additionally or alternatively, at least a portion of the debris may be allowed to fall from the gas head, for example in a cleaning area of an additive manufacturing system or build volume.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An additive manufacturing system comprising:
a build surface;
one or more laser energy sources;
an optics assembly movable relative to the build surface and configured to direct laser energy from the one or more laser energy sources toward the build surface to fuse a portion of a precursor material on the build surface;
a gas head operatively coupled to the optics assembly and moveable relative to the build surface, wherein the gas head is configured to entrain emitted materials released during fusion of the precursor material; and
a gas head cleaning device comprising a scraper configured to remove debris from a surface of the gas head.

2. The system of claim 1, wherein the build surface, the gas head, and the gas head cleaning device are disposed within a build volume of the additive manufacturing system.

3. The system of claim 1, further comprising a cleaning area separate from the build surface, wherein the gas head cleaning device is disposed in the cleaning area.

4. The system of claim 1, wherein the gas head cleaning device comprises a longitudinal shaft and one or more limbs extending radially from the longitudinal shaft, each limb comprising a scraper.

5. The system of claim 4, wherein the longitudinal shaft is coupled to at least one of a motor configured to rotate the longitudinal shaft about a longitudinal axis of the shaft, and a linear actuator configured to translate the gas head cleaning device in a linear direction.

6. The system of claim 5, comprising the linear actuator, wherein the linear actuator is configured to move the gas head cleaning device between a storage position below the build surface and a cleaning position above the build surface.

7. The system of claim 4, wherein the one or more limbs comprises a first limb extending in a first radial direction from the longitudinal shaft and a second limb extending in a second radial direction opposite the first radial direction.

8. The system of claim 7, wherein the first limb extends from a first point along the longitudinal shaft and the second limb extends from a second point along the longitudinal shaft offset from the first point.

9. The system of claim 7, wherein the first limb and the second limb extend from a same point along the longitudinal shaft.

10. The system of claim 4, wherein the one or more limbs comprises:
a first limb extending from a first point along the longitudinal shaft in a first radial direction, the first limb having a first scraper configured to clean a first surface of the gas head, and
a second limb extending from a second point along the longitudinal shaft in the first radial direction, the second limb having a second scraper configured to clean a second surface of the gas head.

11. The system of claim 4, wherein at least one limb has a first scraper extending from a first side of the limb configured to clean a first surface of the gas head, and a second scraper extending from a second side of the limb configured to clean a second surface of the gas head.

12. The system of claim 4, wherein the surface of the gas head is disposed at an angle relative to the build surface, and wherein an angle of at least one limb relative to the longitudinal shaft is selected to correspond to the angle of the surface.

13. The system of claim 4, wherein each scraper is selectively removable from the respective limb, each limb comprising a slot configured to slidably receive a coupling root of the respective scraper.

14. The system of claim 4, wherein each scraper comprises a metallic brush or a plastic brush.

15. A method of cleaning a gas head of an additive manufacturing system, the method comprising:
moving the gas head to an area of the additive manufacturing system suitable for cleaning the gas head;
separating debris from a surface of the gas head with a gas head cleaning device of the system; and
removing debris from the gas head.

16. The method of claim 15, wherein moving the gas head to the area of the additive manufacturing system suitable for cleaning the gas head comprises moving the gas head to a cleaning area adjacent to and separate from a build surface of the additive manufacturing system.

17. The method of claim 15, wherein separating debris from the surface of the gas head comprises separating debris from an internal surface of the gas head.

18. The method of claim 17, wherein separating debris from the internal surface of the gas head comprises separating debris from an upper internal surface and/or a lower internal surface of the gas head.

19. The method of claim 15, wherein separating debris from the surface of the gas head comprises separating debris from an external surface of the gas head.

20. The method of claim 15, wherein separating debris from the surface of the gas head comprises:
separating debris from a first surface with a first scraper of the gas head cleaning device; and
separating debris from a second surface with a second scraper of the gas head cleaning device.

21. The method of claim 20, wherein the first and second surfaces of the gas head are on a first duct of the gas head, and wherein debris is separated from the first and second surfaces simultaneously.

22. The method of claim 20, wherein the first surface is on a first duct of the gas head and the second surface is on a second duct of the gas head.

23. The method of claim 22, wherein debris is separated from the first and second surfaces simultaneously.

24. The method of claim 22, wherein separating debris from the second surface comprises moving the first duct from an extended configuration to a retracted configuration to space the first surface apart from the first scraper, and moving the second duct from a retracted configuration to an extended configuration to place the second scraper in contact with the second surface.

25. The method of claim 15, wherein separating debris from the surface of the gas head comprises:
moving the gas head cleaning device from a storage position below a build surface of the additive manufacturing system to a cleaning position above the build surface;
engaging a scraper of the gas head cleaning device with the surface of the gas head; and
moving the gas head in at least one direction to pass the scraper along the surface of the gas head.

26. The method of claim 25, wherein moving the gas head cleaning device from the storage position to the cleaning position comprises translating the gas head cleaning device in a linear direction, and wherein engaging the scraper of the gas head cleaning device with the surface of the gas head comprises rotating the gas head cleaning device to place the scraper in contact with the surface.

27. The method of claim 26, wherein translating the gas head cleaning device in the linear direction comprises moving at least a portion of the gas head cleaning device into a gap between two ducts of the gas head.

28. The method of claim 15, wherein separating debris from the surface of the gas head comprises dislodging debris from the surface using a brush of the gas head cleaning device.

29. The method of claim 15, wherein removing debris from the gas head comprises creating a flow of gas through the gas head, and entraining debris in the flow of gas.

30. The method of claim 15, further comprising fusing precursor material with laser energy from one or more laser energy sources to form one or more parts on a build surface.

31. A part manufactured using the method of claim 15.
